(19) United States
(12) Patent Application Publication
(10) Pub. No.: US 2007/0255851 A1
(43) Pub. Date: Nov. 1, 2007

(54) ADAPTIVE DATA REDUCTION FOR PERFORMANCE ENHANCEMENT OF LARGE DATA SET DISPLAYS

(76) Inventors: Joseph A. Vrba, Clinton, TN (US); Mark W. Slemp, Knoxville, TN (US); Kai T. Bouse, Tellico Plains, TN (US)

Correspondence Address: LUEDEKA, NEELY & GRAHAM, P.C., P O BOX 1871, KNOXVILLE, TN, 37901, US

(21) Appl. No.: 11/380,437

(22) Filed: Apr. 27, 2006

(51) Int. Cl. G06F 15/16

(52) U.S. Cl. 709/246

(57) ABSTRACT

A method for adaptive test data reduction is performed by cooperative software applications running on a client computer and a server computer. On the client, a plotting application requests a range of test data, such as by specifying a starting time and either an ending time or a total number of data samples desired. The client application also specifies the number of points desired for display of the requested data, where the number of points is based on the screen size and resolution of the display device. Based on the client request, the server scans the requested data set and condenses it to produce a reduced resolution data set that is compatible with the display properties of the display device. The method prevents computers from having to send (or receive) more data than is actually needed to produce a desired data display. The method according to the invention saves considerable communication bandwidth and client processing time by performing data reduction at the server before the data is transferred to the client.

### FIELD

This invention relates to the field of test data reduction and viewing. More particularly, this invention relates to a system for reducing the amount of data transferred from a server computer for display at a client computer.

### BACKGROUND

In manufacturing and other industrial environments, machines are often monitored to detect faults and verify proper operation. For example, a machine's vibration may be continuously monitored and alarms generated if the vibration exceeds a predetermined threshold at some frequency of interest. In some machines, temperature and fluid pressures may be monitored. These monitoring systems typically incorporate various types of sensors attached to the monitored machine. These sensors generate signals that are transferred to a computer where they are analyzed and in some cases stored for future reference.

During transient machine conditions, such as startups or shutdowns, data from multiple sensors is sampled at high frequency and retained as a continuous, unbroken stream. This data is referred to as transient data. Depending on the machine being monitored and the type of data collected, transient data sets may be quite large. These large data sets are often stored on central server computers and are accessed for viewing and analysis on client computers via a network connection.

In some cases, transient data is stored that allows display of continuous waveforms collected over periods longer than 24 hours. For example, at a sample rate of 5120 Hz, a 24-hour waveform for one signal may consist of over 44 million measurements. Although a data analyst may want to “see” the entire 24-hour waveform, the resolution of a typical display screen limits the amount of data that can be plotted to a maximum of about 1000 points at a time. Obviously, it would be quite inefficient to transmit 44 million values from the server computer to the client computer for plotting when only about 1000 points can be displayed.

What is needed, therefore, are cooperative techniques for efficient management of transient data transfers from a server computer to a client computer. These techniques should provide “intelligent” data reduction to minimize network traffic and improve system performance.

### SUMMARY

The above and other needs are met by a method for adaptive data reduction that prevents computers from having to send (or receive) more data than is actually needed to produce a desired data display. According to the method, information is provided to a server computer indicating a maximum point count that can be displayed on a client computer and what type of data is to be handled. Based on this information, the server computer quickly scans the data in its memory and produces a reduced data set for display on the client computer. This reduced data set essentially provides the same display as would have been generated the “standard way”—that is, by transmitting the entire data set to the client and the client then creating the plot from the entire set—except that the method according to the invention saves considerable communication and client processing time by doing the data reduction at the server before the data is transferred to the client. An added benefit of the invention is speed, since server machines tend to be much faster than client machines.

In a preferred embodiment of the invention, the method is performed by cooperative data reduction and analysis software applications running on the client computer and the server computer. On the client, a plotting application requests a range of data. This range is usually specified by a starting time and either the duration or the number of data samples desired. The client application also specifies the number of points desired for display of the requested data. Based on the client request, the server computer scans the requested data set and processes it to create a reduced resolution data set of the specified point count.

In one preferred embodiment, the invention provides a method for reducing and displaying test data using a server computer, a client computer and a display device associated with the client computer. The method includes steps of:
(a) inputting range information at the client computer indicating a range of the test data to be displayed on the display device;
(b) ascertaining display information at the client computer, where the display information is related to the screen size and resolution of the display device on which the test data is to be displayed;
(c) submitting a request from the client computer to the server computer for the range of the test data, where the request is based on the range information and the display information;
(d) loading the requested data set into memory at the server computer, where the contents of the requested data set are determined based on the request from the client computer;
(e) condensing the requested data set at the server computer to generate a condensed data set;
(f) providing the condensed data set to the client computer; and
(g) displaying the condensed data set on the display device.

In some preferred embodiments, the data reduction operation is performed based on a value N, which is a ratio of a total number of data samples in the requested data set to a displayable point count, where the displayable point count is an integer value determined based on the screen size and resolution of the display device.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a data collection reduction and analysis system according to a preferred embodiment of the invention;

FIG. 2 depicts a flow chart of a method for adaptive data reduction according to a preferred embodiment of the invention; and

FIGS. 3A-3D depict examples of data reduced and plotted according to preferred embodiments of the invention.

### DETAILED DESCRIPTION

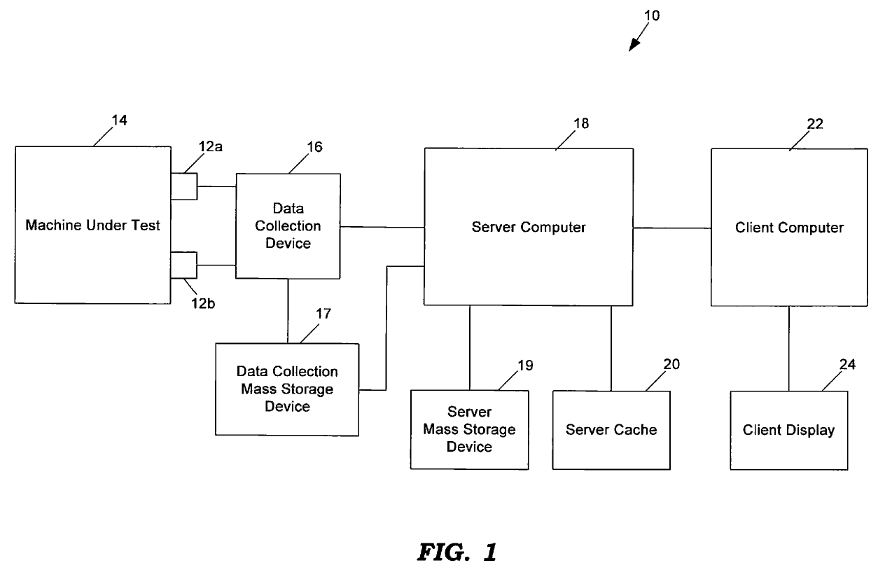

FIG. 1 depicts an example of a system 10 for collecting and analyzing test data. In the illustrated system 10, sensors 12a and 12b are attached to a machine-under-test 14 for collecting machine test data. For example, the sensors 12a-b may be accelerometers for measuring vibration characteristics of the machine 14. A data collection device 16 receives sensor signals from the sensors 12a-b, conditions the signals, and converts the signals into digital data for storage on a local mass storage device 17. An example of such a data collection device is the Model 4500-T manufactured by CSI Technology. Inc. A server computer 18 accesses transient data from the data collection device 16 or directly from the local mass storage device 17. In preferred embodiments, the server 18 extracts portions of the data and copies that data to a mass storage device 19 associated with the server 18 for archival. The server 18 includes cache memory 20 for temporary data storage.

In the preferred embodiment, a client computer 22 is connected by a network to the server computer 18. Through the network, the client computer 22 has access to the test data stored on the server 18. In alternative embodiments, the functions of the client and the server are performed by a single computer. The client computer 22 includes a display device 24, such as an LCD or CRT display, on which visual displays of test data may be generated.

In the preferred embodiment of the invention, the method of test data reduction and display is performed using cooperative software applications running on the server 18 and on the client 22. Using these software applications, the server 18 and the client 22 work together to access desired test data from the server 18 and to quickly and efficiently display the test data for a user at the client 22. When reference is made herein to the client 22 or the server 18 performing some action, it should be appreciated that the action is performed based on execution of the software applications.

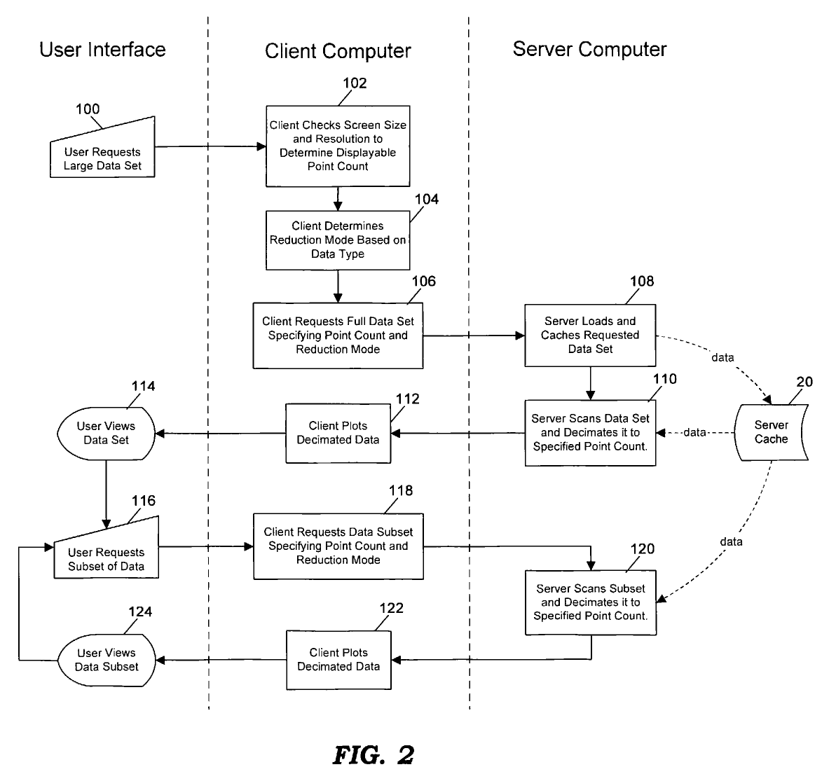

FIG. 2 depicts a preferred method implemented by the software applications on the server 18 and the client 22 for accessing the test data from the server 18 and providing the data to the client 22. At the client 22, a user enters a request for display of a large set of test data that is available from the server 16 (step 100). The user may specify the data to be displayed based on a start time and duration. For example, the requested data set may be continuous vibration data collected on the machine 14 for a period of 24 hours prior to some machine event, such as a mechanical failure of some sort. The data may be displayed as vibration power versus time over the 24 hour period. Although vibration data is used as an example in describing operation of the invention, it will be appreciated that the method described herein is applicable to other types of data displayed in various other types of formats.

Based on the user input, the client 22 determines the screen size and resolution of the client display device 24 on which the requested data is to be displayed (step 102). Based on the screen size and resolution of the display 24, the client 22 determines a point count indicating the number of data points that are displayable. This displayable point count is referred to herein as n_{dpc}. Based on the type of requested data, the client 22 also determines what data reduction mode the server 18 will apply in reducing the data. (step 104). Differences between various data reduction modes applied by the server 18 are discussed in more detail hereinafter.

The client 22 then communicates a request to the server 18 for the full data set requested by the user (step 106). This request from the client 22 specifies the point count (determined at step 102), the data reduction mode (determined at step 104) and the data range. Based on the request from the client 22, the server 18 loads the requested data set from a mass storage device and caches the requested data in the server cache 20 (step 108).

Based on the displayable point count and data reduction mode, the server 18 scans the requested data set in the cache 20 and condenses it to match the displayable point count that can be handled by the display device 24 (step 110). In the preferred embodiment of the inventio, the server 18 condenses the requested data set according to one of three data reduction modes as described in Table 1 below. In the mode descriptions, N is an integer value representing a ratio of the total number of data samples in the requested data range, nₜₒₜₐₗ, to the displayable point count, n_{dpc}. Thus,

$$N = \frac{{n}_{total}}{{n}_{dpc}} . \qquad ( 1 )$$

In the preferred embodiment of the invention, the data reduction modes include a simple mode, an average mode and a minimum/maximum mode. However, it should be appreciated that other reduction methods could be applied, and the invention is not limited to any particular scheme for data reduction.

TABLE I

| Reduction | |
|---|---|
| Mode | Description |
| Simple | Every Nth sample is returned as a point. Also |
| | referred to as “subsample” mode. |
| Average | Sequential groups of N consecutive samples are |
| | averaged together and returned as points. |
| Min/Max | Sequential groups of 2N consecutive samples are |
| | scanned to locate the minimum and maximum values |
| | within each group. The minimum and maximum values |
| | are returned as points. Also referred to as “peak” mode. |

The server 18 provides the condensed data set to the client 22 for plotting on the display device 24 (step 112). The user may then view the displayed data and determine whether to “zoom in” for viewing a subset of the requested data set (step 114). For example, the user may wish to view in greater detail a two hour portion of the 24-hour data set. In this case, the user enters a request at the client computer 22 for a subset of the large data set (step 116). The client 22 then communicates a request to the server 18 for the desired subset of data (step 118). This request from the client 22 preferably specifies the range of points to display, the data reduction mode and the desired point count. Based on the specified range of data points and data reduction mode, the server 18 scans the subset of data samples in the cache 20 and condenses the data to match the displayable point count that can be handled by the display device 24 (step 120). The condensed data is then plotted on the client display device 24 (step 122) for viewing by the user (step 124). This process of zooming in (or zooming out) in the cached data set may be repeated any number of times as the user views data portions of interest.

Since a smaller overall range of data samples is scanned and condensed at step 120, the resolution of the condensed data is higher than that of the condensed data returned at step 110. Although the resolution of the data returned at step 120 is higher than that returned at step 110, the same number of data points are returned, which number matches the screen size and resolution of the display device 24. Thus, as the user “zooms in” to display particular portions of the large data set, the resolution of the displayed data is increased while maintaining the displayable point count that matches the screen size and resolution of the display 24. Most importantly, the data reduction steps are preferably performed at the server 18 rather than the client 22, thereby reducing the overall amount of data transferred to the client 22 and increasing the overall speed of the process.

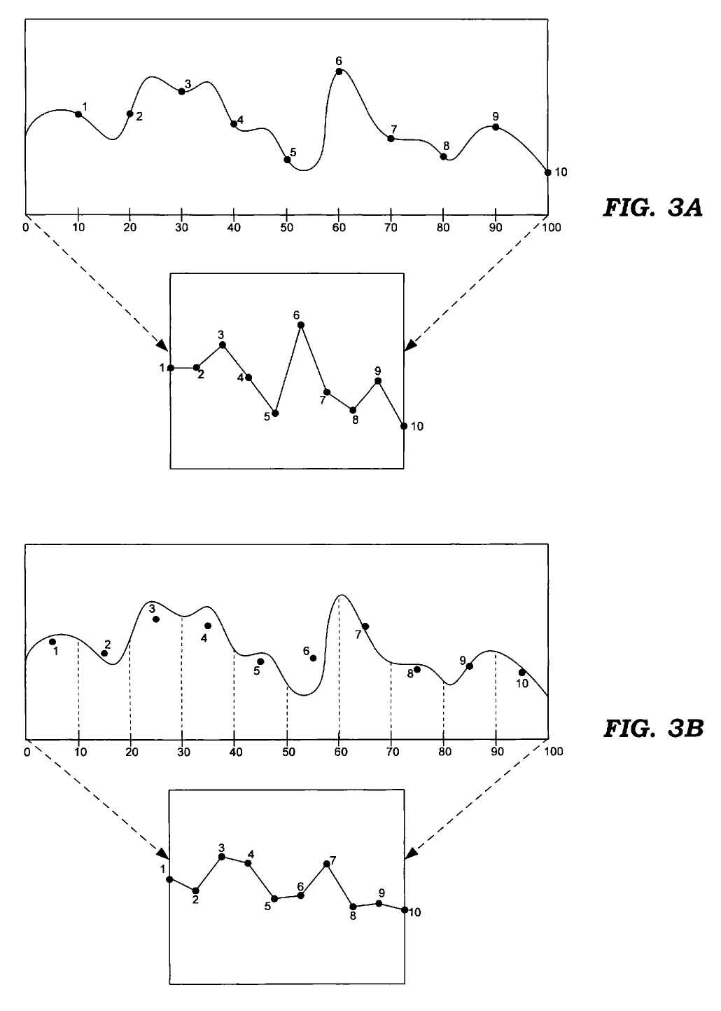

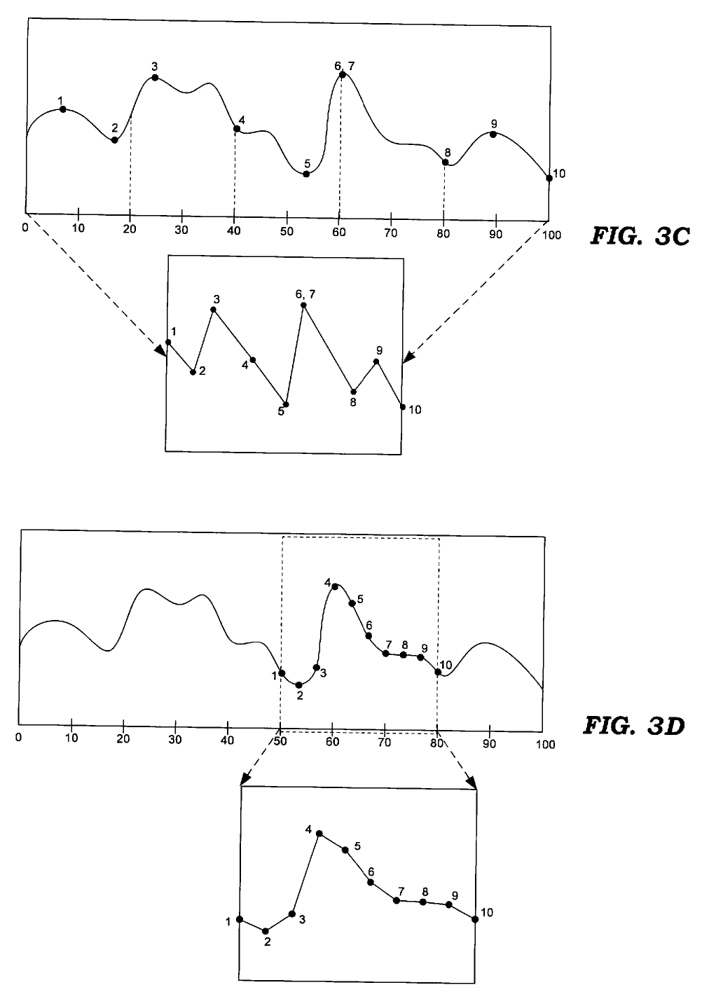

FIGS. 3A-3D depict examples of data extracted, condensed and plotted according to a preferred embodiment of the invention. For purposes of illustration, it is assumed that the large data set plotted in the upper portions of FIGS. 3A-3D consists of 100 data samples (nₜₒₜₐₗ=100). This 100-sample data set corresponds to the data loaded into the server cache 20 at step 108 of FIG. 2. It is further assumed that the displayable point count of the display device is ten (n_{dpc}=10). Thus, for the examples of FIGS. 3A-3C,

$$N = \frac{{n}_{total}}{{n}_{dpc}} = \frac{100}{10} = 10.$$

(As discussed below, N takes on a different value in the example of FIG. 3D.)

The lower portion of FIG. 3A depicts a plot of data condensed using the “simple” data reduction mode described in Table 1. According to this method, every 10^{th} data point of the 100 samples is returned for plotting at the client display device. Thus, a total of ten data points are returned for plotting on the display device, which corresponds to the resolution of the display device.

The lower portion of FIG. 3B depicts a plot of the same 100-sample data set condensed using the “average” data reduction mode. According to this method, the average of the first 10 samples is returned as the first data point (point 1), the average of the second 10 samples is returned as the second data point (point 2), and so forth. Again, the method returns ten data points for plotting.

The lower portion of FIG. 3C depicts a plot of the same 100-sample data set condensed using the “min/max” data reduction mode. According to this method, the minimum and maximum points of the first 20 samples are returned as the first and second data points (points 1 and 2), the minimum and maximum points of the second 20 samples are returned as the third and fourth data points (points 3 and 4), and so forth. This data reduction method also returns ten data points for plotting which matches the screen size and resolution of the display device.

FIG. 3D depicts an example of an application of the “simple” data reduction method to “zoom in” on a portion of the 100-sample data set in the server cache 20. In this example, the client 22 communicates a request to the server 18 for a 30-point subset of the data (points 51-80 in FIG. 3D). For this example,

$$N = \frac{{n}_{total}}{{n}_{dpc}} = \frac{30}{10} = 3.$$

Thus, as shown in the lower portion of FIG. 3D, every 3^{rd} data point of the 30 points in the zoomed-in section is plotted on the display device 24. This example illustrates how the invention adjusts the resolution of the displayed data depending on the number of data points in the portion to be displayed. A comparison of the lower portion of FIG. 3A (between points 5 and 8) to the lower portion of FIG. 3D clearly indicates the difference in resolution.

In a preferred embodiment of the invention, the data values returned by the data reduction methods discussed above are also converted from their archived 32-bit or 64-bit floating point format to 16-bit integer values for display. This results in a further data size reduction of 2:1 or 4:1.

Other data reduction techniques may also be applied, depending on the type of data collected. For example, a “peak hold” mode would be applied to power or magnitude spectral data. This mode preserves the maximum of the N data values. For complex frequency data, a “vector sum” mode would be employed which computes both the power and the phase of the N data values.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for reducing and displaying test data using a server computer, a client computer and a display device associated with the client computer, the method comprising steps of:
(a) inputting at the client computer first range information indicating a first range of the test data to be displayed on the display device;
(b) ascertaining at the client computer display information regarding aspects of the display device on which the test data is to be displayed;
(c) submitting a first request from the client computer to the server computer for the first range of the test data, wherein the first request is based at least in part on the first range information and the display information,
(d) loading a first requested data set into memory at the server computer, the contents of the first requested data set determined based at least in part on the first request from the client computer,
(e) condensing the first requested data set at the server computer to generate a first condensed data set;
(f) providing the first condensed data set to the client computer; and
(g) displaying the first condensed data set on the display device.

2. The method of claim 1 further comprising:
(h) determining a data reduction mode to be applied in performing step (e), the determination of the data reduction mode based at least in part on a type of test data in the first requested data set; and
step (e) comprising condensing the first requested data set based at least in part on the data reduction mode determined in step (h).

3. The method of claim 2 wherein:
step (h) is performed at the client computer; and
the first request of step (c) is based at least in part on the data reduction mode determined at step (h).

4. The method of claim 2 wherein the data reduction mode is selected from the group consisting of a simple mode, an average mode and a minimum/maximum mode.

5. The method of claim 2 wherein step (e) comprises condensing the first requested data set based at least in part on a value N which is a ratio of a total number of data samples in the first requested data set to a displayable point count, where the displayable point count is an integer value determined based on the display information.

6. The method of claim 5 wherein the value N is determined according to:
$$N = \frac{{n}_{total}}{{n}_{dpc}} ,$$
where nₜₒₜₐₗ is the total number of data samples in the first requested data set and n_{dpc} is the displayable point count.

7. The method of claim 5 wherein step (e) comprises condensing the first requested data set using a simple data reduction mode wherein the first condensed data set comprises every Nth data sample of the first requested data set.

8. The method of claim 5 wherein step (e) comprises condensing the first requested data set using an average data reduction mode, wherein a first value in the first condensed data set is an average of a first N consecutive samples of the first requested data set, a second value in the first condensed data set is an average of a second N consecutive samples of the first requested data set, and so forth.

9. The method of claim 5 wherein step (e) comprises condensing the first requested data set using a minimum/maximum data reduction mode, wherein the first two values in the first condensed data set are the maximum and minimum values in the first 2N consecutive samples of the first requested data set, the next two values in the first condensed data set are the maximum and minimum values in the second 2N consecutive samples of the first requested data set, and so forth.

10. The method of claim 1 wherein step (b) includes ascertaining a screen size and resolution of the display device on which the test data is to be displayed.

11. The method of claim 1 further comprising steps of:
(h) receiving at the client computer second range information from the user indicating a second range of the test data to be displayed on the display device;
(i) submitting a second request from the client computer to the server computer for the second range of test data, wherein the second request is based at least in part on the second range information;
(j) locating a second requested data set in the memory at the server computer, the contents of the second requested data set determined based at least in part on the second request submitted from the client computer;
(k) condensing the second requested data set at the server computer to generate a second condensed data set, the second condensed data set being of higher resolution than the first condensed data set;
(l) providing the second condensed data set to the client computer, and
(m) displaying the second condensed data set on the display device.

12. The method of claim 11 wherein the second requested data set is a subset of the first requested data set.

13. The method of claim 11 wherein the second range of test data is a subset of the first range of test data.

14. The method of claim 11 wherein a total number of data samples in the second requested data set is less than a total number of data samples in the first requested data set.

15. The method of claim 11 wherein a total number of data samples in the second condensed data set is equivalent to a total number of data samples in the first condensed data set.

16. A method for reducing and displaying test data using a server computer, a client computer and a display device associated with the client computer, the method comprising steps of:
(a) inputting range information at the client computer, the range information indicating a range of the test data to be displayed on the display device;
(b) determining at the client computer a data reduction mode to be applied in reducing the test data, the data reduction mode based at least in part on a type of test data to be displayed;
(c) ascertaining display information at the client computer, the display information indicative of aspects of the display device on which the test data is to be displayed:
(d) submitting a request from the client computer to the server computer for the range of the test data, wherein the request is based at least in part on the range information and the display information;
(e) loading a requested data set into memory at the server computer, the contents of the requested data set determined based at least in part on the request from the client computer;
(f) condensing the requested data set at the server computer to generate a condensed data set, the condensing based at least in part on the data reduction mode determined in step (b) and based at least in part on a value N which is a ratio of a total number of data samples in the requested data set to a displayable point count, where the displayable point count is an integer value determined based on the display information;
(g) providing the condensed data set to the client computer; and
(h) displaying the condensed data set on the display device.
